(19) United States
(12) Patent Application Publication
(10) Pub. No.: US 2023/0416092 A1
(43) Pub. Date: Dec. 28, 2023

(54) SELECTIVE PHOSPHATE EXTRACTION

(71) Applicant: SUSPHOS B.V., Amsterdam (NL)

(72) Inventors: Willem Johan SCHIPPER, Amsterdam (NL); Victor Olusola AJAO, Amsterdam (NL)

(73) Assignee: SUSPHOS B.V., Amsterdam (NL)

(21) Appl. No.: 18/035,812

(22) PCT Filed: Nov. 9, 2021
(86) PCT No.: PCT/NL2021/050686

§ 371 Date: May 8, 2023

(30) Foreign Application Priority Data
Nov. 9, 2020 (NL) 2026857

(51) Int. Cl. C01B 25/22

(52) U.S. Cl. CPC C01B 25/22

(57) ABSTRACT

The invention relates to a process for the production of phosphoric acid, phosphoric acid obtainable by the process, the production of ammonium phosphate salts, and to the use of ammonium salts. A process for the production of phosphoric acid, comprising: i) reacting a phosphorus-containing material with an acid, without organic solvent, thereby forming a reaction mixture comprising phosphoric acid, wherein said acid has a pKa of 3.5 or lower, and ii) extracting phosphoric acid from the reaction mixture by adding organic solvent to the reaction mixture, thereby forming a phosphoric acid solution, wherein 20 wt. % or less of free water is added to the reaction mixture, based on the total weight of the reaction mixture, and the phosphorus-containing material comprises secondary raw material comprising phosphate.

The invention is in the field of the production of phosphoric acid and phosphates. The invention can be integrated in the phosphate producing industry as it provides a commercially interesting process. In particular, the invention pertains to the production and uses of phosphoric acid and derivative salts, specifically from secondary phosphates, such as waste streams. The invention relates to a process for the production of phosphoric acid and phosphoric acid obtainable by the process. The invention also relates to the production of ammonium phosphate salts and to uses of the salts as, for example, as fertilizer material, flame retardant, feed additive or yeast nutrient.

Phosphorus is an essential element for life, used in fertilizers, flame retardants and many other chemical products. Phosphorus is almost exclusively sourced from mines, and most of the phosphorus products ends up in landfills, bound to soils, or in waterways or other effluents after being used, and lost for reuse. This is not a sustainable approach.

In general, phosphoric acid, the basic feedstock for phosphate fertilizers, is obtained through acid attack (sulfuric acid, or exceptionally hydrochloric acid) on phosphate rock (Ullmann's Technical Encyclopedia). This technology has been known for over a century and forms the basis of phosphoric acid and most derivative phosphate containing compounds, chiefly fertilizers but also technical, feed and food grade phosphates.

It is known that if phosphate is present in a (dilute) phosphoric acid form, this can be extracted using an organic solvent (IN 201647036270). Much is known about the production of phosphoric acid from rock using a water-miscible solvent to extract the phosphates and produce a purified phosphoric acid (GB-A-1 345 710, and U.S. Ser. No. 05/881,087 among many others).

Bi-phasic systems for phosphate extraction have also been demonstrated, yielding the phosphate in an organic fraction. If one can extract the phosphoric acid from the organic fraction, a high concentration of acid may result, often in purified form. In specific cases, the phosphate is precipitated from the organic fraction to yield an insoluble phosphate salt.

In order to prepare for a circular economy and continue to have a steady supply of phosphate and derivatives even if the primary sources, i.e., the phosphate mines, become poorer in resource, there is a need to look at waste recycling, in particular the recycling of waste with phosphate content. Certain waste materials exist that contain relatively high amounts of phosphorus. Examples include struvite, vivianite, bone-meal ash, sewage sludge ash and others. For these sources to become a useful and economically viable source of phosphate products, one needs a simple, highly efficient and cost-effective way of selectively obtaining valuable phosphate out of the waste.

Using a traditional wet-process on these secondary phosphates has many challenges. The traditional process, starting from phosphate rock, what is essentially calcium phosphate (apatite), relies on the near-insolubility of calcium sulfate in water and phosphoric acid.

For example, FR-1.480.663 discloses a process of producing phosphoric acid, which comprises acidulating traditional phosphate rock. The process is an extension of the usual water-based production of phosphoric acid as performed on large scale by the industry. The process requires preheating of the phosphate rock, as supported by an example in FR-1.480.663 of the unacceptably low effectivity of the procedure if heating is not included. Heating of large masses of phosphate sources is costly, as far as investment and operational costs are concerned. Hence, it is particularly undesirable to heat phosphate sources on a large scale. For example, in the case of powdery phosphates, such materials tend to be carried to a considerable extent into the off-gas stream, causing loss of efficiency. As a result, costly equipment need to be installed, such as cyclones and bag filters, to prevent the phosphates from being dispersed into the environment and being lost to the process.

Where phosphate rock primarily contains calcium phosphate, secondary phosphates, such as struvite, vivianite and sewage sludge ashes, contain other constituents, such as phosphates of iron, aluminum, magnesium and/or ammonium. The sulfates of iron, aluminum, magnesium and ammonium are significantly soluble in water and phosphoric acid, thus preventing any meaningful separation of these constituents by precipitation from the phosphoric acid formed. Their removal from phosphoric acid is not trivial, and is associated with large capital and operational costs.

Many processes have been proposed to recycle phosphates into useful products.

For instance, EP-A-3 266 742 discloses a method to produce phosphoric acid from secondary materials, such as struvite or sewage sludge ash, by means of electrodialysis. However, the method needs expensive and complicated equipment, uses significant amounts of electrical power, and produces a dilute phosphoric acid which needs to be concentrated to reach commercial strength.

WO-A-2019/125 293 describes a method to dissolve struvite in hydrochloric acid, followed by extraction with a non-miscible organic extractant. As is known to those skilled in the art, such a process comprises the use of mixer-settlers, pulsed columns, agitated columns, non-agitated columns, inline mixers, centrifugal contactors, etc. This makes such a process expensive to build and operate. Also, it is well known that such processes are sensitive to disruptions caused by, for example, varying input parameters.

An objective of the invention is to address one or more of the disadvantages faced in the prior art. It is a further objective of the invention to provide an alternative to biphasic extraction systems and avoid additional complexity. Other objectives include reducing the extraction time of phosphate and omitting the need for grinding of phosphorus-containing material. A particular objective is to provide an efficient and low-cost process for the production of phosphoric acid.

The inventors found that one or more of these objectives can be met, at least in part, by the direct acidulation of phosphorus-containing material and using the intrinsic exothermicity of the reaction.

Accordingly, a process for the production of phosphoric acid is provided, comprising:
i) reacting a phosphorus-containing material with an acid and without organic solvent, thereby forming a reaction mixture comprising phosphoric acid, wherein said acid has a pKa of 3.5 or lower, and
ii) extracting phosphoric acid from the reaction mixture by adding organic solvent to the reaction mixture, thereby forming a phosphoric acid solution,
   wherein preferably 20 wt. % or less of free water is added to the reaction mixture, based on the total weight of the reaction mixture.

Compared to known methods and processes for producing phosphoric acid, the invention takes a new and innovative approach to provide a fast, high-yield, simple conversion of phosphorus-containing materials, in particular secondary phosphate sources, to give a high-purity, highly concentrated phosphoric acid product and byproducts. The innovative extraction process of the invention relates to monophasic extraction of phosphate to provide a straightforward and economically interesting extraction process that is ideally suited for producing phosphoric acid needed for, for example, fertilizers. With the invention, product and byproducts are separated in an uncomplicated manner. Separation problems encountered with traditional wet-processes are overcome by, for example, using an organic solvent in which phosphoric acid is soluble, but the other byproducts, such as constituents mentioned in this disclosure, for example sulfates of calcium, iron, aluminum and magnesium, are only sparingly soluble, or insoluble.

In a first aspect of the invention there is provided a process for the production of phosphoric acid, comprising:
i) reacting a phosphorus-containing material with an acid and without organic solvent, thereby forming a reaction mixture comprising phosphoric acid, wherein said acid has a pKa of 3.5 or lower, and
ii) extracting phosphoric acid from the reaction mixture by adding organic solvent to the reaction mixture, thereby forming a phosphoric acid solution,
   wherein 20 wt. % or less of free water is added to the reaction mixture, based on the total weight of the reaction mixture, and the phosphorus-containing material comprises secondary raw material comprising phosphate.

In a further aspect of the invention there is provided phosphoric acid obtainable by a process according to the process in the first aspect of the invention. The process further comprises removing solvent from the phosphoric acid solution to obtain phosphoric acid. The phosphoric acid has a strength of at least 50 wt. % of P205 by total weight of the phosphoric acid, preferably 75 wt. % or more.

In yet a further aspect of the invention there is provided the use of ammonium phosphate salt obtainable by a process according to the process in the first aspect of the invention, as fertilizer material, flame retardant, feed additive, or yeast nutrient. The process further comprises adding a reactant to the phosphoric acid solution that reacts with phosphoric acid to form the ammonium phosphate salt (i.e., ammoniating).

In a general sense, the invention is based on the judicious insight to extract phosphate from phosphorus-containing materials, in particular secondary phosphate sources, with an efficient and straightforward process. By acidulating phosphorus-containing material without organic solvent and in the presence of a low weight percentage of free water, high concentrations of phosphoric acid can be reached, as described in this disclosure, thereby rendering it a surprisingly commercially interesting process. The invention provides a simple, yet effective way to selectively extract valuable phosphate from phosphorus-containing (waste) material, including secondary phosphate sources comprising iron and/or aluminum, e.g., found in waste streams, such as sewage sludge incineration ash, to yield phosphoric acid having P₂O₅ concentrations of, for example, up to 90 wt. %, which can be marketed directly or transformed into commercially interesting phosphate salts.

When referring to a noun (e.g., an ammonium phosphate salt, an acid, a solvent, etc.) in the singular, the plural is meant to be included, or it follows from the context that it should refer to the singular only.

The term “crystalline frameworks” as used in this disclosure is meant to refer to crystalline frameworks of, for example, a salt. The crystalline frameworks can originate, at least in part, from the phosphorus-containing material. Water can be found in crystalline frameworks. Such water can be removed from a crystalline framework by, for example, heating or solubilizing the crystalline framework. Hence, the phrase “water originating from crystalline frameworks”. The water content of compounds can be determined with thermogravimetric analysis, nuclear magnetic resonance spectroscopy, and even X-ray diffraction crystallography.

The term “free water” as used in this disclosure is meant to refer to water that originates from a state wherein the water is not bound to, for example, solid matter, such as crystalline frameworks or phosphorus-containing material as described in this disclosure. In particular, the term refers to water that is added as such and/or as part of a solution. Unlike the traditional wet-process, there is preferably very little (i.e., 20 wt. % or less) or no water added to the process (e.g., reaction mixture) so that the phosphoric acid produced is of high concentration and high purity as described in this disclosure. In particular, very little free water, such as 20 wt. % or less of free water, or no free water may be introduced into the process by the phosphorus-containing material and/or acid.

The term “phosphoric acid” as used in this disclosure is meant to refer to phosphorus oxoacid. In particular, the term is used to refer to phosphoric acids, wherein each phosphorus atom is bonded to four oxygen atoms, one of them through a double bond, and arranged at the corners to form a tetrahedron-shaped molecule. The phosphorus may have an oxidation state of +5. In addition, the phosphoric acid may comprise one or more PO₄ tetrahedra, thereby forming linear or branched chains, cycles, or more complex structures. Examples of such phosphoric acids are orthophosphoric acid, pyrophosphoric acid, oligophosphoric acid, such as triphosphoric acid, super phosphoric acid and polyphosphoric acid.

The phrase “without organic solvent” as used in this disclosure is meant to indicate that organic solvent is not present or present in a minute amount. In particular, the amount of organic solvent may be about 5 wt. % or less by total weight of the reaction mixture, such as 4 wt. % or less, 3 wt. % or less, 2 wt. % or less, or about 1 wt. % or less. Preferably, the amount of organic solvent in the reaction mixture is 0.5 wt. % or less by total weight of the reaction mixture, such as 0.25 wt. % or less, or 0.1 wt. % or less. More preferably, the reaction mixture is (essentially) free of organic solvent.

The invention is applicable to the extraction of phosphate from, for example, secondary raw material comprising phosphate, and phosphate rock. The invention can provide local markets with a supply of highly pure and concentrated phosphoric acid and phosphate derivatives as defined in this disclosure, without relying on mines that may be far away and whose supply is difficult to secure. The invention makes it available to process large sources of, for example, recycled phosphorus, such as struvite and/or sewage sludge ash, for the extraction of phosphate.

The invention provides a monophasic extraction process for the production of phosphoric acid. The process comprises reacting phosphorus-containing material with an acid. In particular, the phosphorus-containing material is acidulated directly by adding the acid to the material. During acidulation, or acid attack, the structure of the phosphorus-containing material may at least partially be (chemically and/or physically) destroyed. By directly acidulating the phosphorus-containing material, high reaction temperatures can be reached that further drive the reaction forward in a short time span. This, in combination with a low free water content of the reaction mixture (e.g., 20 wt. % or less), will significantly drive the reaction forward. Such destruction of phosphorus-containing material may be represented by a series of reactions between the acid and components of the phosphorus-containing material. For example, when the acid comprises sulfuric acid, phosphate salts, such as calcium phosphate, will be converted at least partially to calcium sulfate and phosphoric acid.

Surprisingly, the inventors found that by acidulating phosphorus-containing material, in particular secondary phosphates (secondary raw material comprising phosphate) that comprise, for example, iron and/or aluminum, such as sewage sludge ashes, with a water content as defined in this disclosure, especially in the absence of water, autogenous heating occurs, which is sufficient to allow high-yield conversion of the material to phosphoric acid. Subsequently, the phosphoric acid can be selectively extracted using a solvent as defined in this disclosure. As a result, the invention avoids the complexity and costs of traditional processes, such as those described in the prior art mentioned in this disclosure.

The phosphorus-containing material may comprise secondary raw material comprising phosphate, and/or phosphate rock. In particular, the phosphorus-containing material comprises secondary raw material comprising phosphate. The phosphorus-containing material may be secondary raw material comprising phosphate. Secondary raw material comprising phosphate can be any suitable poor, used, rejected and/or depleted material, comprising phosphate, such as wastes from the agri-food industry, sludge, etc., for further use. For example, the secondary phosphate-containing material may be provided from a phosphate recovery operation. In particular, the phosphorus-containing material comprises one or more selected from the group consisting of apatite, calcium phosphate, struvite, vivianite, sewage sludge ash, meat and bone meal ash, and manure ash. Preferably the material comprises one or more selected from struvite, vivianite, sewage sludge ash, meat and bone meal ash, calcium phosphate, and manure ash. More preferably, the material comprises struvite and/or sewage sludge ash.

The acid is characterized by having a pKa of at most 3.5. When a reference in this disclosure is made to a pKa value, in the case of a polyprotic acid, the pKa value may be any of its pKa values, preferably the first ionization constant (pKa₁). The lower the pKa value the stronger the acid. In particular, the acid has a pKa of 3.0 or lower, such as 2.5 or lower, 2.2 or lower, 2.0 or lower, 1.5 or lower, 1.0 or lower, 0.5 or lower, or even about 0.0 or lower. Preferably, the acid has a pKa of −0.5 or lower, such as −1.0 or lower, −1.5 or lower, −2.0 or lower, or −3.0 or lower.

In particular, the acid comprises one or more inorganic acids. Exemplary inorganic acids include sulfuric acid, nitric acid, hydrochloric acid, phosphoric acid, perchloric acid, and the like. Sulfuric acid may be selected having any concentration, particularly of at least about 60%, preferably at least about 80%, such as about 96% or 98%. Nitric acid may have a concentration of about 68% or higher. Hydrochloric acid of any concentration may be selected, in particular of at least about 30%, such as about 34% or higher. Phosphoric acid of any concentration may be selected, such as in the range of about 75-85%. Perchloric acid of any concentration may be selected, particularly of about 60% or higher, such as about 70% or higher. Preferably, the acid comprises one or more selected from sulfuric acid, phosphoric acid, nitric acid and hydrochloric acid. More preferably, the acid comprises sulfuric acid, such as sulfuric acid having a concentration of about 96-98%.

With the reaction between the phosphorus-containing material and the acid, a reaction mixture is formed that comprises phosphoric acid. The reaction is performed without organic solvent, as described in this disclosure. For example, the reaction mixture may comprise 2 wt. % or less of organic solvent by total weight of the reaction mixture. Preferably, the reaction is performed in the absence of any organic solvent.

The reaction between the phosphorus-containing material and the acid is typically a spontaneous, exothermic reaction. Hence, the temperature at which the reaction occurs depends on the reaction input mixture. The reaction typically does not require active heating. The temperature at which the reaction proceeds is dependent among others on the starting temperature, the heat generated in the reaction and the cooling/heating means applied externally to the reaction. The temperature should be sufficient to effectively convert the phosphorus-containing material to form phosphoric acid. Thereto, the reaction mixture may be actively heated. The temperature at which the reaction occurs may be between about 50° C. and about 250° C., such as about 90-210° C. At temperatures below 50° C., the reaction occurs slowly and may not reach completion. After the reaction, the temperature of the reaction mixture is typically allowed to drop, thereby reaching, for example, a temperature of at most about 100° C.

The process may further comprise a step of cooling the reaction mixture prior to the extraction. Preferably, the cooling step comprises external cooling. With the cooling step, dissolved salts may crystallize such that the filtration of precipitates becomes easier and/or mixing of the organic solvent with the reaction mixture is made possible without losing a significant part of the solvent intended for the extraction by evaporation.

The process further comprises a step of extracting phosphoric acid from the reaction mixture by adding organic solvent to the reaction mixture. In particular, the organic solvent is phosphoric acid-miscible. Preferably, the organic solvent is water-miscible. That is, the organic solvent and water may form a homogeneous mixture when mixed.

Organic solvent is typically, but not necessarily, added to the reaction mixture at a temperature below a boiling point at atmospheric pressure of the organic solvent. The organic solvent may be an oxygen-containing organic solvent, for example, having between 1 and 18 carbon atoms. The organic solvent may comprise one or more alcohols, ethers, nitriles, and/or ketones. Alcohols and ketones are particularly useful as solvents. In particular, the organic solvent comprises one or more members selected from the group consisting of C₁-C₁₈ alkyls and alkylene mono- and polyalcohols, ketones and ethers. The organic solvent may comprise one or more selected from acetone, butanone, methyl isobutyl ketone, methanol, ethanol, isopropanol, tetrahydrofuran, dioxane, diisopropyl ether, acetonitrile, methyl t-butyl ether, and methyl ether ketone. The boiling point at atmospheric pressure of the organic solvent may be at least 35° C., and preferably not higher than 100° C. Accordingly, the solvent may comprise one or more selected from acetone, butanone, methanol, ethanol, isopropanol, tetrahydrofuran, diisopropyl ether, acetonitrile, methyl t-butyl ether, and methyl ether ketone. In particular, the boiling point of the solvent is 50-90° C. Hence, the organic solvent preferably comprises acetone, methanol, ethanol, isopropanol, and/or diisopropyl ether. Preferably, the boiling point of the solvent is 55-85° C. More preferably, the organic solvent comprises acetone, isopropanol, methanol and/or ethanol. Particularly good extraction results have been obtained using solvents that do not form an azeotrope with water. Re-using the solvent within the process may be performed by, e.g., solvent distillation. If water is added to the process by, e.g., the intrinsic water content of one of the reactants, a solvent forming an azeotrope with water will add water to the process in a subsequent cycle in an uncontrolled manner, which is undesired. Hence, the organic solvent as described in this disclosure preferably does not form an azeotropic mixture with water. Accordingly, even more preferably, the organic solvent comprises acetone.

In particular, according to the process, 20 wt. % or less of free water by total weight of the reaction mixture is added to the reaction mixture. The amount of free water added to the reaction mixture may be wt. % or less, such as 14 wt. % or less, 13 wt. % or less, 12 wt. % or less, 11 wt. % or less, or 10 wt. % or less. Preferably, the amount of free water added to the reaction mixture is 5 wt. % or less, such as 4 wt. % or less or 3 wt. % or less. More preferably, the amount of free water added to the reaction mixture is 2 wt. % or less, such as 1 wt. %. Even more preferably, essentially no free water is added to the reaction mixture (i.e., about 0 wt. % of the reaction mixture). Without being bound by theory it is believed that a small amount of free water added to the reaction mixture contributes to obtaining soluble phosphoric acid(s) and/or phosphate compound(s) in high yields and purities as described in this disclosure. One of the reasons for adding 20 wt. % or less of free water to the reaction mixture is the desirability of obtaining phosphoric acid in high concentrations as described in this disclosure, which can, for example, be shipped at a minimum of expense. In addition, by adding such a low amount of free water to the reaction mixture, the extraction step results inter alia in a re-usable solvent for a subsequent cycle with a desirable lower water content.

Besides free water, water may be present in the reaction mixture as it originally resided in, for example, crystalline frameworks. Depending on, for example, the composition of the phosphorus-containing material, the amount of water from crystalline frameworks may vary. Accordingly, the reaction mixture may comprise near zero weight percent by total weight of the reaction mixture, for example, in the case of sewage sludge, or more, such as at least 30 wt. % of water originating from crystalline frameworks. In particular, the reaction mixture may comprise 40 wt. % or more of water from crystalline frameworks, such as 45 wt. % or more or 50 wt. % or more.

Free water can also reside in the phosphorus-containing material. The phosphorus-containing material and/or the acid may comprise free water. The amount of free water in either may vary, depending on the composition of the phosphorus-containing material and/or the acid. In particular, the phosphorus-containing material and the acid combined may comprise 20 wt. % or less of free water by the total combined weight of the phosphorus-containing material and acid. The phosphorus-containing material and acid combined may comprise 15 wt. % or less of free water, such as 13 wt. % or less or 11 wt. % or less. Preferably, the amount of free water in the phosphorus-containing material and acid combined is 10 wt. % or less, such as 9 wt. % or less, 8 wt. % or less, 7 wt. % or less, or 6 wt. % or less. More preferably, the amount of free water in the phosphorus-containing material and acid combined is 5 wt. % or less, such as 4 wt. % or less, 3 wt. % or less, or 2 wt. % or less. Even more preferably, the amount of free water in the phosphorus-containing material and acid combined is 1 wt. % or less, based on their combined total weight. It is believed that such amounts of free water in the phosphorus-containing material and acid combined contribute to the direct acidulation of the phosphorus-containing material and an exothermic reaction between said material and the acid. As such, less heat or even no heat is required to drive the acidulation reaction. Hence, by keeping the amount of free water low in the phosphorus-containing material and acid combined, the reaction between said material and acid may become spontaneous and/or exothermic.

The process may further comprise adding phosphoric acid. The phosphoric acid may be added either prior to extraction step ii), such as to step i), for example, to the reaction mixture under step i); between steps i) and ii); and/or during extraction step ii), such as prior to adding organic solvent to the reaction mixture, at the same time as adding organic solvent and/or after adding organic solvent. In particular, phosphoric acid may be added to step i), such as to the phosphorus-containing material and/or to the reaction mixture; and/or between steps i) and ii). The phosphoric acid may comprise entirely of phosphoric acid formed by the process or in part. For example, the phosphoric acid may comprise 5 wt. % or more of the formed phosphoric acid by total weight of the phosphoric acid, such as 10 wt. % or more, 15 wt. % or more, 20 wt. % or more, 25 wt. % or more, or 30 wt. % or more. The phosphoric acid may comprise 95 wt. % or less of the formed phosphoric acid by total weight of the phosphoric acid, such as 90 wt. % or less, 85 wt. % or less, 80 wt. % or less, 75 wt. % or less, or 70 wt. % or less. In particular, the phosphoric acid comprises 10-90 wt. % of the formed phosphoric acid, such as 20-80 wt. % or 30-70 wt. %. By adding phosphoric acid to the process, for example, the ratio between solids and liquids, such as those described in this disclosure, in the reaction mixture may be favorably affected, thereby improving the homogeneity of the reaction mixture and/or the extraction of phosphoric acid.

With the process a molar ratio between the acid, calculated as protons, and phosphorus in the phosphorus-containing material, calculated as P, may be 1:1 or more. In particular, the molar ratio between the acid and the phosphorus-containing material is between about 1:1 to about 15:1. Preferably, the molar ratio is from about 3:1 to about 12:1.

The process may further comprise a step of removing solvent from the phosphoric acid solution to obtain phosphoric acid as described in this disclosure. Solvent may be removed from the solution by distillation, such as fractional or azeotropic distillation, molecular sieving, etc.

After the phosphoric acid is extracted from the reaction mixture, the phosphoric acid solution may still additionally contain small amounts of sulfate. Solids that may reside in the phosphoric acid solution after extraction may primarily be composed of calcium sulfate with small amounts of other impurities found in the phosphorus-containing material. Any conventional filtration apparatus may be used to separate the solution containing the phosphoric acid from the solids. Consecutive washing steps may be further performed to allow optimal separation of the dissolved phosphoric acid from the solids. It is desired to produce phosphoric acid of high purity. The amount of sulfate in the solution may be reduced by partial evaporation of the solvent. With that procedure sulfate salts precipitate, which may then be removed by further filtration. However, since the amount of sulfate in the solution may be minute, the further purification step is not necessary for every purpose. Because of the high selectivity of the extraction process, most other components present in the phosphorus-containing material, including magnesium, iron, calcium, ammonium, pathogens and bacteria, are not extracted in appreciable amounts, and are either filtered off as solids together with the sulfates in the primary filtration step, or destroyed in the process.

The invention allows for the production of highly concentrated phosphoric acids, in particular when the water content during the acidulation reaction is kept at amounts in this disclosure. The highly concentrated phosphoric acids include, for example, super phosphoric acid and polyphosphoric acid. Traditional methods for producing such phosphoric acids typically require either significant amounts of thermal energy to drive out water from ordinary phosphoric acid, or the addition of phosphorus pentoxide as made through the energy-intensive white phosphorus synthesis route. To obtain phosphoric acid from the solution, evaporation of the solvent and recovery for subsequent use is preferred. Upon distillation or evaporation of the solvent, phosphoric acid of different concentrations phosphorus pentoxide (P₂O₅) may result. Phosphoric acid may be obtained having at least 35 wt. % P₂O₅, for example between about 35 wt. % P₂O₅ and about 100 wt. % P₂O₅, such as between about 35 wt. % P₂O₅ and about 90 wt. % P₂O₅. The phosphoric acid may have a P₂O₅ concentration of 40 wt. % or more, such as 45 wt. % or more, 50 wt. % or more, 55 wt. % or more, or 60 wt. % or more, and/or, for example, 100 wt. % or less, 95 wt. % or less, 90 wt. % or less, 85 wt. % or less, such as 80 wt. % or less, 75 wt. % or less, or 70 wt. % or less. For example, the phosphoric acid may have a P₂O₅ concentration of 40-90 wt. %, such as 55-85 wt. %, 60-80 wt. %, or 50-70 wt. %. Preferably, the phosphoric acid has 65 wt. % or more of P₂O₅, such as 70 wt. % or more, 75 wt. % or more, 80 wt. % or more, or 85 wt. % or more. More preferably, the phosphoric acid has 75 wt. % or more of P₂O₅, such as 80 wt. % or more, for example 75-100 wt. % or 80-95 wt. %. The concentration of the phosphoric acid depends inter alia on the amount of water added or present in the reaction mixture. The phosphoric acid may readily be further concentrated by, e.g., heating the acid to drive off water.

Alternatively, phosphoric acid may be precipitated from the phosphoric acid solution to form a salt. The precipitate can be separated from the solution by readily available technologies. Ammoniation (treatment with ammonia and/or a derivative thereof) of the solution may result in the formation of pure ammonium phosphate precipitate which may be readily removed by filtration. The precipitate may further be dried or washed and dried to recover solvent and produce solids that are suitable for commercial sale. This water-soluble compound is, for example, a highly valuable fertilizer. The high degree of insolubility of ammonium phosphates in organic solvents as described in this disclosure, makes such a precipitation markedly different from precipitation in traditionally used watery systems, where ammonium phosphates are highly soluble and need to be crystallized by evaporating large amounts of water. Whereas the precipitation of ammonium phosphates with traditional water-based systems is energy inefficient (energy intensive), the invention allows ammonium phosphate to easily precipitate with high purity. In addition, precipitation of ammonium phosphates with traditional water-based systems results in highly contaminated mother lye comprising significant amounts of phosphate that can neither be used to produce pure ammonium phosphate nor discarded because of its value.

Animal feed may be provided by adding a calcium compound to the organic solvent in the form of a source of calcium ions to precipitate calcium phosphate. Sodium hydroxide neutralization of the extraction solvent may result in the precipitation of sodium phosphates, which are products of considerable commercial interest. Neutralization with potassium compounds, such as potassium hydroxide, may yield precipitate of potassium phosphate, which can be useful in technical and food applications. Accordingly, it can be seen that phosphoric acid can readily be separated from the solution by, for example, evaporation and/or precipitation in the form of a salt.

Hence, the process may further comprise a step of adding a reactant, such as any of the above described reactants, to the phosphoric acid solution that reacts with phosphoric acid to form a phosphate salt. The reactant may be selected from calcium compounds; sodium compounds; and/or potassium compounds, preferably any such compound as described in this disclosure. For example, the process may further comprise a step of ammoniating the phosphoric acid solution to form an ammonium phosphate salt. Thus, there is also provided ammonium phosphate salt obtainable by the process, wherein the process further comprises the step of ammoniating the phosphoric acid solution to form the ammonium phosphate salt.

The ammonium phosphate may comprise impurities, such as those that can be found in the phosphoric acid, including metals, e.g., aluminum, magnesium, iron and calcium, fluorine, unreacted phosphoric acid, solvent, acid etc. In particular, the ammonium phosphate comprises 20 wt. % or less of impurities based on the total weight of the ammonium phosphate. Preferably, the ammonium phosphate comprises 10 wt. % or less of impurities, such as 5 wt. % or less. More preferably, the ammonium phosphate comprises 3 wt. % or less of impurities, such as 2 wt. % or less, or even 1 wt. % or less.

In a preferred embodiment of the process of the invention, the phosphorus-containing material comprises struvite and/or sewage sludge ash, the acid comprises an inorganic acid, preferably sulfuric acid as described in this disclosure, and the organic solvent comprises one or more selected from acetone, isopropanol, methanol, ethanol, preferably comprising acetone. In addition, preferably 10 wt. % or less of free water is added to the reaction mixture, such as 5 wt. % or less.

Yet further provided is a process for the production of ammonium phosphate salt(s). This process may comprise the same steps as the process of the invention. The process comprises:
i) reacting phosphorus-containing material, preferably as defined in this disclosure, such as comprising secondary raw material comprising phosphate, with an acid, preferably as defined in this disclosure, and without organic solvent, thereby forming a reaction mixture comprising phosphoric acid, wherein said acid has a pKa of 3.5 or lower, and
ii) extracting phosphoric acid from the reaction mixture by adding organic solvent, preferably as defined in this disclosure, to the reaction mixture, thereby forming a phosphoric acid solution,
iii) adding a reactant, preferably as defined in this disclosure, for example comprising ammonia, to the phosphoric acid solution, thereby forming an ammonium phosphate salt,
   wherein preferably 20 wt. % or less of free water is added to the reaction mixture, based on the total weight of the reaction mixture.

Depending on, for example, the reactant or the combination of reactants, monoammonium phosphate salt and/or diammonium phosphate salt can be produced with the aforementioned process. Hence, the ammonium phosphate salt as described in this disclosure may be, or comprise, monoammonium phosphate salt and/or diammonium phosphate salt.

The invention further provides phosphoric acid obtainable by a process as defined in this disclosure. In particular, said process is in accordance with the process of the first aspect of the invention, and further comprises removing solvent from the phosphoric acid solution, thereby obtaining phosphoric acid. The phosphoric acid has a strength of at least 35 wt. % of P₂O₅ by total weight of the phosphoric acid, and may be up to as high as about 100 wt. % of P₂O₅, such as up to 90 wt. % P₂O₅. In particular, the phosphoric acid comprises 40 wt. % or more of P₂O₅, such as 45 wt. % or more, 50 wt. % or more, 55 wt. % or more, 60 wt. % or more, and/or, for example, 100 wt. % or less, such as 95 wt. % or less, 90 wt. % or less, 85 wt. % or less, 80 wt. % or less, 75 wt. % or less, or 70 wt. % or less. For example, the phosphoric acid obtainable by said process may have a P₂O₅ concentration of 35-100 wt. %, such as 40-90 wt. %, 55-85 wt. %, 60-80 wt. %, or 50-70 wt. %. Preferably, the phosphoric acid has a strength of 65 wt. % or more of P₂O₅, such as 70 wt. % or more, 75 wt. % or more, 80 wt. % or more, or 85 wt. % or more. More preferably, the phosphoric acid has 75 wt. % or more of P₂O₅, such as 80 wt. % or more, for example 75-100 wt. % or 80-95 wt. %. The phosphoric acid may further comprise a small amount of impurities as described in this disclosure, such as those that can be found in the phosphoric acid, including metals, e.g., aluminum, magnesium, iron and calcium; fluorine; solvent; acid; etc. The small amount of impurities can be 10 wt. % or less by total weight of the phosphoric acid. In particular, the phosphoric acid comprises 7 wt. % or less of impurities, such as 5 wt. % or less or 3 wt. % or less. Preferably, the phosphoric acid comprises 2 wt. % or less of impurities, such as 1 wt. % or less.

The invention also provides the use of ammonium phosphate salt obtainable by a process as defined in this disclosure, as fertilizer material, flame retardant, feed additive, or yeast nutrient (e.g., for winemaking). The process may be in accordance with the process in the first aspect of the invention, and further comprises adding a reactant to the phosphoric acid solution that reacts with phosphoric acid to form an ammonium phosphate salt. The process may be in accordance with the process for the production of ammonium phosphate salts provided in this disclosure. In particular, monoammonium phosphate salt and/or diammonium phosphate salt may be used as fertilizer material, whereas diammonium phosphate salt may be used as a precursor to produce flame retardants, such as ammonium polyphosphate, or as a flame retardant.

The invention has been described by reference to various embodiments, and methods. The skilled person understands that features of various embodiments and methods can be combined with each other.

All references cited in this disclosure are hereby completely incorporated by reference to the same extent as if each reference were individually and specifically indicated to be incorporated by reference and were set forth in its entirety in this disclosure.

The use of the terms “a” and “an” and “the” and similar referents in the context of describing the invention (especially in the context of the claims) are to be construed to cover both the singular and the plural, unless otherwise indicated in this disclosure or clearly contradicted by context. The terms “comprising”, “having”, “including” and “containing” are to be construed as open-ended terms (i.e., meaning “including, but not limited to”) unless otherwise noted. Recitation of ranges of values herein are merely intended to serve as a shorthand method of referring individually to each separate value falling within the range, unless otherwise indicated in this disclosure, and each separate value is incorporated into the specification as if it were individually recited in this disclosure. The use of any and all examples, or exemplary language (e.g., “such as”) provided in this disclosure, is intended merely to better illuminate the invention and does not pose a limitation on the scope of the invention unless otherwise claimed. No language in the specification should be construed as indicating any non-claimed element as essential to the practice of the invention. For the purpose of the description and of the appended claims, except where otherwise indicated, all numbers expressing amounts, quantities, percentages, and so forth, are to be understood as being modified in all instances by the term “about”. Also, all ranges include any combination of the maximum and minimum points disclosed and include any intermediate ranges therein, which may or may not be specifically enumerated in this disclosure.

Preferred embodiments of this invention are described in this disclosure. Variation of those preferred embodiments may become apparent to those of ordinary skill in the art upon reading the foregoing description. The inventors expect skilled artisans to employ such variations as appropriate, and the inventors intend for the invention to be practiced otherwise than as specifically described in this disclosure. Accordingly, this invention includes all modifications and equivalents of the subject-matter recited in the claims appended hereto as permitted by applicable law. Moreover, any combination of the above-described elements in all possible variations thereof is encompassed by the invention unless otherwise indicated in this disclosure or otherwise clearly contradicted by context. The claims are to be construed to include alternative embodiments to the extent permitted by the prior art.

For the purpose of clarity and a concise description features are described in this disclosure as part of the same or separate embodiments, however, it will be appreciated that the scope of the invention may include embodiments having combinations of all or some of the features described.

Hereinafter, the invention will be illustrated in more detail, according to specific examples. However, the invention may be embodied in many different forms and should not be construed as being limited to the embodiments set forth in this disclosure. Rather, these example embodiments are provided so that this description will be thorough and complete, and will fully convey the scope of the invention to those skilled in the art.

### EXAMPLES

Synthesis of Phosphoric Acid from Struvite with No Added Free Water

294.5 g dried struvite (1.2 mol) was added to a blender, after which 100.5 ml H₂SO₄ (96%, 1.88 mol) was added slowly. The reactants were blended for 1-2 mins and during the process, the temperature of the reaction mixture increased to 85-98° C. (depending on the insulation level of the blender). A syrupy, semi-transparent liquid was obtained. The blender was stopped and the blender cup cooled in ice until less than 40° C. 600 ml acetone was added to the partly solidified cooled reaction mixture and blended for 1 min to extract phosphoric acid to the organic solvent. The mixture was transferred to a 3.5 liter reactor and mixed at 600 rotations per minute. An additional 400 ml acetone was added to the blender, mixed and transferred to the reactor. The resulting reaction mixture contained solid residues and phosphoric acid dissolved in acetone. The solid residues were separated from the solvent via filtration. Additional 500 ml and 200 ml acetone were successively added to the reactor and filtered, as further extraction and washing steps. The combined filtrates from all the filtration steps yielded a total of 6.5% H₃PO₄in acetone. Acetone was evaporated on a solvent evaporator to obtain pure solvent-free phosphoric acid. The total yield of the pure phosphoric acid was 96% (calculated as phosphorus based on the phosphorus content in the starting material).

Synthesis of Phosphoric Acid from Struvite with a Small Amount of Water Added

294.5 g dried struvite (1.2 mol) was added to a blender. 17.7 ml H₂O (0.98 mol) was first added, after which 100.5 ml H₂SO₄ (96%, 1.88 mol) was added slowly. The reactants were blended for 1-2 mins and during the process, the temperature of the reaction mixture increased to 80-95° C. (depending on the insulation level of the blender). The blender was afterwards cooled in ice until less than 40° C. 600 ml acetone was added to the partly solidified cooled reaction mixture and blended for 1 min to extract phosphoric acid to the organic solvent. The mixture was transferred to a 3.5 liter reactor and mixed at 600 rotations per minute. An additional 400 ml acetone was added to the blender, mixed and transferred to the reactor. The resulting reaction mixture contained solid residues and phosphoric acid dissolved in acetone. The solid residues were separated from the solvent via filtration. Additional 500 ml and 200 ml acetone were successively added to the reactor and filtered, as further extraction steps. The combined filtrates from all the filtration steps yielded a total of 5.8% H₃PO₄ in acetone. Acetone was evaporated on a solvent evaporator to obtain a more concentrated phosphoric acid. The total yield of the pure phosphoric acid was 98% (calculated as phosphorus based on the phosphorus content in the starting material).

### Extraction Using Different Solvents

Phosphoric acid extraction after the acidulation process was carried out using different types of solvents (Table 1). In all the experiments, 294.5 g dried struvite (1.2 mol) was added to a blender. 17.7 ml H₂O (0.98 mol) was first added, after which 100.5 ml H₂SO₄ (96%, 1.88 mol) was added slowly. The reactants were blended for 1-2 mins and during the process, the temperature of the reaction mixture increased to 80-95° C. (depending on the insulation level of the blender). The blender was afterwards cooled in ice until less than 40° C. 600 ml organic solvent was added to the partly solidified cooled reaction mixture and blended for 1 min to extract phosphoric acid to the solvent. The mixture was transferred to a 3.5 liter reactor and mixed at 600 rotations per minute. An additional 400 ml solvent was added to the blender, mixed and transferred to the reactor. The resulting reaction mixture contained solid residues and phosphoric acid dissolved in the solvent. The solid residues were separated from the solvent via filtration. Additional 500 ml and 200 ml solvent were successively added to the reactor and filtered, as further extraction steps. The filtrates from the filtrations steps were combined and the results are given in table 1.

TABLE 1
Phosphoric acid extraction with different solvents.

| Solvent | Yield |
|---|---|
| Acetone | 98 |
| Isopropanol | 91 |
| Isopropanol azeotrope (12.2 vol. % water) | 93 |

What is claimed herein:

1. A process for the production of phosphoric acid, the process comprising:
i) reacting a phosphorus-containing material with an acid, without organic solvent, thereby forming a reaction mixture comprising phosphoric acid, wherein said acid has a pKa of 3.5 or lower, and
ii) extracting phosphoric acid from the reaction mixture by adding at least one organic solvent to the reaction mixture, thereby forming a phosphoric acid solution,
wherein 20 wt. % or less of free water is added to the reaction mixture, based on the total weight of the reaction mixture, and
the phosphorus-containing material comprises secondary raw material comprising phosphate.

2. The process according to claim 1, wherein the phosphorus-containing material and the acid combined comprise an amount of 20 wt. % or less of free water by their combined total weight.

3. The process according to claim 2, wherein the phosphorus-containing material and the acid combined comprise an amount of 10 wt. % or less of free water by their combined total weight.

4. The process according to claim 1, wherein 10 wt. % or less of free water is added to the reaction mixture.

5. The process according to claim 1, wherein the reaction mixture comprises at least 30 wt. % of water originating from crystalline frameworks by total weight of the reaction mixture.

6. The process according to claim 1, wherein the organic solvent is added to the reaction mixture having a temperature below a boiling point at atmospheric pressure of the organic solvent.

7. The process according to claim 1, wherein the phosphorus-containing material comprises one or more of: apatite, calcium phosphate, struvite, vivianite, sewage sludge ash, meat and bone meal ash.

8. The process according to claim 1, wherein the phosphorus-containing material comprises struvite.

9. The process according to claim 1, wherein the phosphorus-containing material comprises sewage sludge ash.

10. The process according to claim 1, wherein said acid has a pKa of 2.2 or lower.

11. The process according to claim 1, wherein said acid comprises one or more inorganic acids.

12. The process according to claim 1, wherein the at least one organic solvent is water-miscible.

13. The process according to claim 1, wherein the organic solvent comprises one or more alcohols, ethers, nitriles or ketones.

14. The process according to claim 1, wherein the organic solvent comprises one or more of: acetone, methanol, ethanol, isopropanol, and diisopropyl ether.

15. The process according to claim 1, wherein the at least one organic solvent comprises acetone.

16. (canceled)

17. The process according to claim 1, wherein a molar ratio between said acid, calculated as protons, and phosphorus in the phosphorus-containing material, calculated as P, is 1:1 or more.

18. The process according to claim 17, wherein the molar ratio is 3:1 to 12:1.

19. The process according to claim 1, further comprising at least one of:
a) adding phosphoric acid to at least one of step i) and step ii);
b) ammoniating the phosphoric acid solution to form an ammonium phosphate salt; and
c) removing the at least one organic solvent from the phosphoric acid solution.

20.-24. (canceled)

25. The process according to claim 11 said one or more inorganic acids comprises one or more of: sulfuric acid, phosphoric acid, nitric acid and hydrochloric acid.
